(19) United States
(12) Patent Application Publication
(10) Pub. No.: US 2021/0007462 A1
(43) Pub. Date: Jan. 14, 2021

(54) Formulation Blending Bottles

(71) Applicant: Linda Thuy Cao, Houston, TX (US)

(72) Inventor: Linda Thuy Cao, Houston, TX (US)

(21) Appl. No.: 16/509,622

(22) Filed: Jul. 12, 2019

(51) Int. Cl. A45D 34/04; B01F 13/00

(52) U.S. Cl. CPC A45D 34/048; B01F 13/005; A45D 2200/1009; A45D 34/043; B01F 2215/0031; B01F 13/0022

(57) ABSTRACT

Provided herein is bottle and stirrer combination for mixing a cosmetic formulation. The bottle has a bottle body, a neck, a cap, and an applicator and the stirrer comprises a magnetic material. The stirrer has a shape and dimensions smaller than the inner surface of the base of the bottle body which enables mixing or blending of the cosmetic formulation in the presence of a rotating magnetic field.

### BACKGROUND OF THE INVENTION

### Field of the Invention

This invention relates to the field of containers for cosmetic formulations. More specifically, the present invention relates to devices for obtaining a uniform suspension, mix or blend of a liquid or gel cosmetic formulation.

### Description of the Related Art

Mixing of non-homogenous liquids to obtain a consistent blended formulation is important in many industries including personal care products, food and paint. Because of chemical and physical properties including non-Newtonian viscosity, it is very difficult to obtain a uniform mixture. Conventional methods for mixing and blending small volumes of non-homogenous liquids by vigorous agitation is time consuming and yet do not yield good results. Current attempts to alleviate this problem by the addition of stainless-steel pellets inside the bottle to assist in blending have not provided significant advantages to the physical agitation methods.

Thus, the prior art is particularly deficient in devices and methods that ensure efficient blending of small quantities of liquids. The present invention fulfills this longstanding need and desire in this art.

### SUMMARY OF THE INVENTION

The present invention is directed to a bottle and stirrer combination. In the combination, the bottle comprises a bottle body comprising a base and a neck formed at a mouth of the bottle body and in fluid connection therewith where the bottle body is designed to contain a cosmetic fluid for dispensing. A cap is removably engageable with the neck and a stirrer comprising a magnetic material is disposed on the base within the bottle body. The present invention is directed to a related bottle and stirrer combination further comprising an applicator made of a non-magnetic material depending longitudinally from an inner surface of the cap into the bottle body.

The present invention is further directed to a bottle and stirrer combination for mixing a cosmetic formulation. In the combination, the bottle comprises a bottle body with a base at a distal end and a mouth at a proximal end and is designed to contain the cosmetic formulation and a neck with exterior threading formed at the mouth of the bottle body and in fluid connection therewith. A cap with interior threading is removably, threadably engageable with the neck and a non-magnetic applicator depends longitudinally from an inner surface of the cap into the bottle body. A stirrer comprising a magnetic material and a non-magnetic coating encasing the stirrer is disposed on the base within the bottle body.

Other and further aspects, features, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIGS. 1A-1D show a bottle and stirrer combination for mixing a cosmetic formulation. FIG. 1A is a view of the bottle with the cap removed showing the threads on the neck, and a stirrer. FIG. 1B is a cross-sectional view of the cap showing the interior threading. FIG. 1C is a view of the bottle and stirrer with the cap covering the neck. FIG. 1D is a view of the bottle and stirrer showing the positioning of the applicator within the bottle and the cap.

FIGS. 2A-2D shows a cylindrical shaped stirrer that is used for blending the formulation. FIG. 2A is a top view of the cylindrical stirrer. FIG. 2B is an interior view of the cylindrical stirrer. FIG. 2C is a transverse cross-sectional view of the cylindrical stirrer. FIG. 2D is a longitudinal cross-sectional view of the cylindrical stirrer.

FIGS. 3A-3D shows an oval shaped or substantially ovoid stirrer used for blending the formulation. FIG. 3A is a top view of the oval shaped magnetic stirrer. FIG. 3B is an interior view of the oval shaped stirrer. FIG. 3C is a transverse cross-sectional view of the oval shaped stirrer. FIG. 3D is a longitudinal cross-sectional view of the oval shaped stirrer.

FIGS. 4A-4C show a Y-shaped stirrer used for blending the formulation. FIG. 4A is a top view of the Y-shaped stirrer. FIG. 4B is an interior view of the Y-shaped stirrer. FIG. 4C is a transverse cross-sectional view of the Y-shaped stirrer.

FIGS. 5A-5C show a X-shaped stirrer used for blending the formulation. FIG. 5A is a top view of the X-shaped stirrer. FIG. 5B is an interior view of the X-shaped stirrer. FIG. 5C is a transverse cross-sectional view showing one arm of the X-shaped stirrer.

### DETAILED DESCRIPTION OF THE INVENTION

As used herein in the specification, “a” or “an” may mean one or more. As used herein in the claim(s), when used in conjunction with the word “comprising”, the words “a” or “an” may mean one or more than one.

As used herein “another” or “other” may mean at least a second or more of the same or different claim element or components thereof. Similarly, the word “or” is intended to include “and” unless the context clearly indicates otherwise. “Comprise” means “include.”

As used herein, the term “about” refers to a numeric value, including, for example, whole numbers, fractions, and percentages, whether or not explicitly indicated. The term “about” generally refers to a range of numerical values (e.g., +1-5-10% of the recited value) that one of ordinary skill in the art would consider equivalent to the recited value (e.g., having the same function or result). For example, a cylindrical shaped stirrer may have a length of about 15 mm to about 20 mm and a width of about 5 mm to about 6 mm. Thus, the invention includes stirrers within a range of lengths and widths that differ from the recited dimensions by the above-defined percentage. In some instances, the term “about” may include numerical values that are rounded to the nearest significant figure.

As used herein, the term “proximal” refers to structures or components of the bottle and stirrer combination nearer to or nearest to the cap on the bottle and “distal” refers to structures or components of the combination farther to or farthest from the cap on the bottle.

As used herein, the term “stirrer” refers to an object comprising a magnetic material that will rotate or spin in the presence of a rotating magnetic field.

In one embodiment of the present invention, there is provided a bottle and stirrer combination, comprising a bottle body comprising a base and a neck formed at a mouth of the bottle body and in fluid connection therewith, where the bottle body is designed to contain a cosmetic formulation for dispensing; a cap removably engageable with the neck; and a stirrer comprising a magnetic material that is disposed on the base within the bottle body.

Further to this embodiment, the bottle and stirrer combination comprises an applicator made of a non-magnetic material depending longitudinally from an inner surface of the cap into the bottle body. In this further embodiment the applicator may comprise a brush or a sponge attached at a distal end thereof. In this further embodiment, the applicator may have a length less than a distance from an inner surface of the cap to the stirrer disposed on the base within the bottle body. In addition, the applicator may be made from at least one material selected from the group consisting of a glass, a polymer, a polymer composite, a non-magnetic metal, and a non-magnetic metal composite.

In both embodiments the neck may be exteriorly threaded and the cap may be interiorly threaded. In both embodiments, the bottle body may have a substantially cuboidal shape, or a substantially cylindrical shape, or a substantially hemispherical shape. In addition, the stirrer may comprise a non-magnetic casing. Furthermore, the stirrer may have dimensions less than areal dimensions of an inner surface of the base of the bottle body. Further still, the stirrer may have a cylindrical shape, a discoid shape, a star shape, a dumbbell shape, an X-shape, or a Y-shape.

In both embodiments, the bottle body and the neck may be independently made from at least one material selected from the group consisting of a glass, a polymer, and a polymer composite. In addition, the cap may be made from at least one material selected from the group consisting of a glass, a polymer, a polymer composite, a non-magnetic metal, and a non-magnetic metal composite.

Furthermore, the cosmetic fluid may be a nail polish, a nail lacquer, a nail sealant, or a nail gel.

In another embodiment of the present invention, there is provided a bottle and stirrer combination for mixing a cosmetic formulation, comprising a bottle body with a base at a distal end and a mouth at a proximal end designed to contain the cosmetic formulation; a neck with exterior threading formed at the mouth of the bottle body and in fluid connection therewith; a cap with interior threading removably, threadably engageable with the neck; a non-magnetic applicator depending longitudinally from an inner surface of the cap into the bottle body; and a stirrer comprising a magnetic material and a non-magnetic coating encasing the stirrer that is disposed on the base within the bottle body.

In this embodiment, the bottle body may have a substantially cuboidal shape, or a substantially cylindrical shape, or a substantially hemispherical shape. The bottle body and the neck may be independently made from at least one material selected from the group consisting of a glass, a polymer, and a polymer composite. In addition, the cosmetic formulation may be a nail polish, a nail lacquer, a nail sealant, or a nail gel. in this embodiment the applicator may have a length less than a distance from the inner surface of the cap to the magnetic stirrer on the base within the bottle body. In addition the non-magnetic applicator may comprise a brush or a sponge attached at a distal end thereof. Furthermore the non-magnetic applicator may have a length less than a distance from the inner surface of the cap to the magnetic stirrer on the base within the bottle body. Further still, the non-magnetic applicator and the cap may be independently made from at least one material selected from the group consisting of a glass, a polymer, a polymer composite, a non-magnetic metal, and a non-magnetic metal composite.

In addition, in this embodiment, the stirrer may have dimensions less than areal dimensions of an inner surface of the base of the bottle body. Representative shapes for the stirrer include but are not limited to a cylindrical shape, a discoid shape, a star shape, a dumbbell shape, an X-shape, or a Y-shape.

Described herein are bottle and stirrer combinations designed to contain and to mix or stir, via a stirrer, a cosmetic formulation or fluid to a uniform consistency within the bottle. Generally, the bottle has a bottle body with a distal base, a proximal mouth and a neck formed at the mouth and in fluid connection with the bottle body and contains the magnetic stirrer which lies on the inner surface of the base. A cap removably engages the neck of the bottle and comprises an applicator attached to and depending from the interior of or the proximal inner surface of the cap into the bottle. Representative examples of a cosmetic formulation or a cosmetic fluid are nail polish, a nail lacquer, a nail sealant, a nail gel, a liquid makeup, or a liquid concealer.

The bottle body has any suitable shape that allows a user to stably place the bottle and stirrer combination on a flat surface. For example, the bottle body may be substantially cuboidal, substantially cylindrical, or substantially hemispherical in shape. The bottle body and the neck may be independently made from any non-magnetic material including, but not limited to a glass, a polymer, and a polymer composite, or a combination of these materials. In a non-limiting example, the bottle body may be glass or a carbonate glass. In another non-limiting example, the bottle body is made from glass, the neck is made from glass and the cap is made from a polymer.

The applicator has at its distal end any means for applying the cosmetic formulation for example, but not limited to, a brush or a sponge. The length of the applicator, including the applying means, is less than a distance from the proximal inner surface of the cap to the stirrer on the base within the bottle body which enables the stirrer to rotate freely in the presence of a rotating magnetic field such as provided by a magnetic stirrer as is known in the art. The applicator and the cap independently may be made from or comprise a non-magnetic material including, but not limited to, a glass, a polymer, a polymer composite, a non-magnetic metal, and a non-magnetic metal composite, or a combination of these materials.

The cap and the neck are provided with a means for removably and securely engaging the cap with the neck. When engaged, the cap enables the formulation to be stirred by the magnetic stirrer at a speed sufficient for quick and uniform mixing without leakage. The secured cap also prevents or significantly decreases evaporation of one or more components in the formulation and prevents spilling should the bottle be knocked over. In one example, the cap is interiorally threaded and the neck is exteriorally threaded such that the cap is screwed onto and off of the neck on the bottle. Alternatively, the cap may be a snap on cap to securely snap onto the neck.

The stirrer comprises a magnetic material, for example, a ferromagnetic material, which may be, but is not limited to, iron, nickel, or cobalt, or a combination of these materials, as are known in the art. The stirrer comprises a non-magnetic casing that encases the magnetic material. The casing is made from material that is inert with respect to the formulation being blended. Examples of such materials include, but are not limited to, a polymer and a polymer composite that is not chemically reactive with the formulation. For example, the stirrer is enclosed in a casing made from polytetrafluoroethylene (PTFE). The stirrer may have any shape including, but not limited to, a cylindrical shape, a discoid shape, a star shape, a dumbbell shape, an X-shape, and a Y-shape. The shape and size of the stirrer is appropriate to the size of the bottle body and viscosity of the cosmetic fluid. In a non-limiting example, the stirrer is cylindrical in shape with a length of about 15 mm to about 20 mm and a width of about 5 mm to about 6 mm.

Particularly, embodiments of the present invention are better illustrated with reference to the Figure(s), however, such reference is not meant to limit the present invention in any fashion. The embodiments and variations described in detail herein are to be interpreted by the appended claims and equivalents thereof.

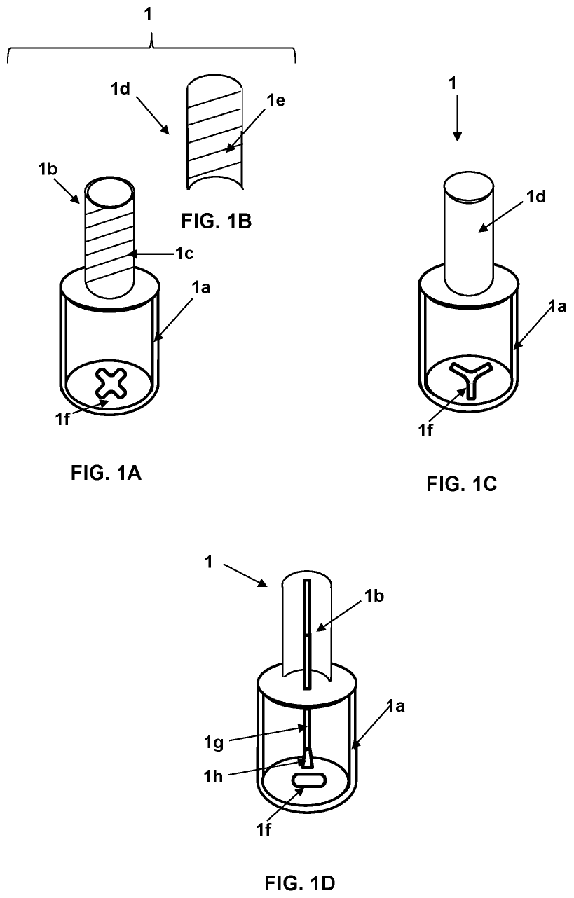

FIG. 1A shows a bottle and stirrer combination 1 with a bottle body 1a and neck 1b with threading 1c around the neck and an X-shaped stirrer 1f disposed therein.

FIG. 1B is a cross sectional view of the cap 1d (see FIG. 1C) showing threading 1e on the inner surface thereof that is engageable with the threading 1c on the neck.

With continued reference to FIG. 1A, FIG. 1C is a view of the bottle 1 with the cap 1d over the neck and showing a Y-shaped stirrer 1F disposed in the bottle.

FIG. 1D shows a bottle and stirrer combination 1 with a bottle body 1a, a cap 1b in cross section, a substantially cylindrical stirrer 1f and an applicator 1g with a brush 1h at a distal end of the applicator for applying the formulation. The cross sectional view of the cap illustrates that the applicator is attached to the proximal inner surface of the cap.

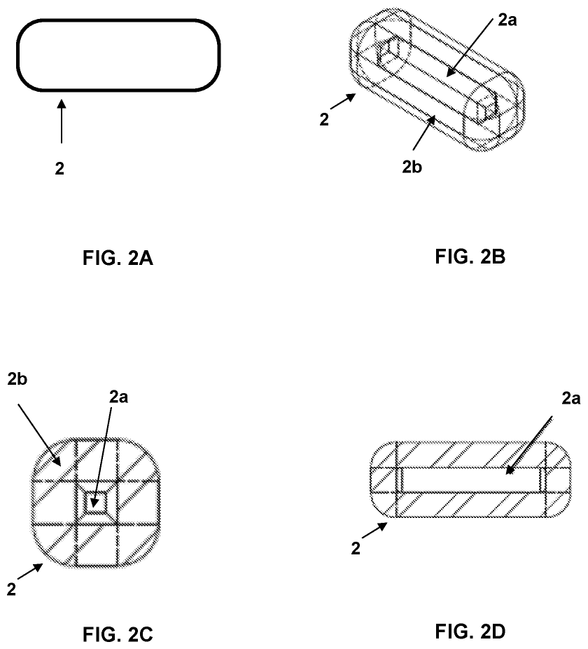

FIG. 2A is a cylindrical shaped stirrer 2 for the bottle and stirrer combination as shown in FIG. 1D.

FIG. 2B is an interior view of the stirrer 2 showing the ferromagnetic material 2a enclosed within a casing 2b.

With continued reference to FIG. 2B, FIG. 2C is a transverse cross-sectional view of the stirrer 2 showing the ferromagnetic material 2a enclosed within a casing 2b.

With continued reference to FIGS. 2B and 2C, FIG. 2D is a longitudinal cross-sectional view of the stirrer 2 showing the ferromagnetic material 2a.

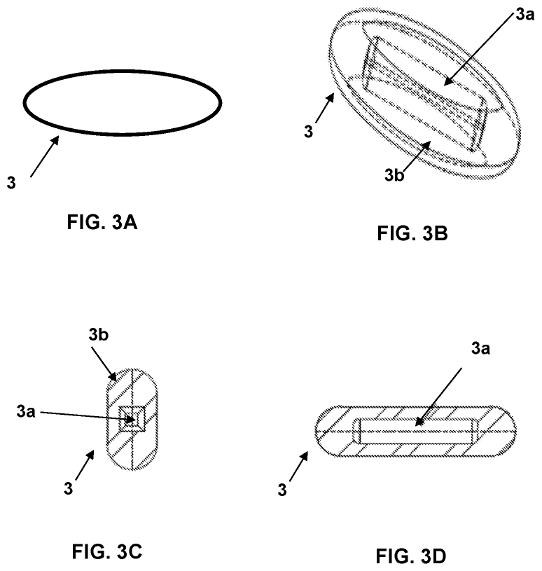

FIG. 3A is an oval shaped or substantially ovoid stirrer 3 for the bottle and stirrer combination.

FIG. 3B is an interior view of the stirrer 3 showing the ferromagnetic material 3a enclosed within a casing 3b.

With continued reference to FIG. 3B, FIG. 3C is a transverse cross-sectional view of the stirrer 3 showing the ferromagnetic material 3a enclosed within a casing 3b.

With continued reference to FIGS. 3B and 3C, FIG. 3D is a longitudinal cross-sectional view of the stirrer 3 showing the ferromagnetic material 3a.

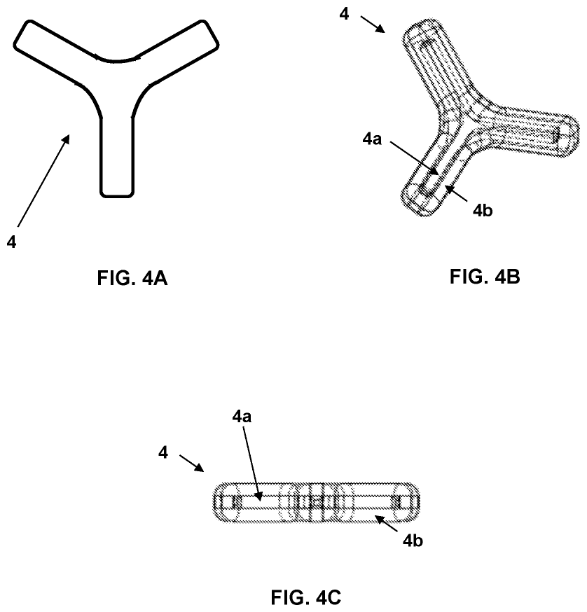

FIG. 4A is a top view of a Y-shaped stirrer 4 for the bottle and stirrer combination.

FIG. 4B is an interior view of the stirrer 4 showing the ferromagnetic material 4a enclosed within a casing 4b.

With continued reference to FIG. 4B, FIG. 4C is a transverse cross-sectional view of the stirrer 4 showing the ferromagnetic material 4a enclosed within a casing 4b.

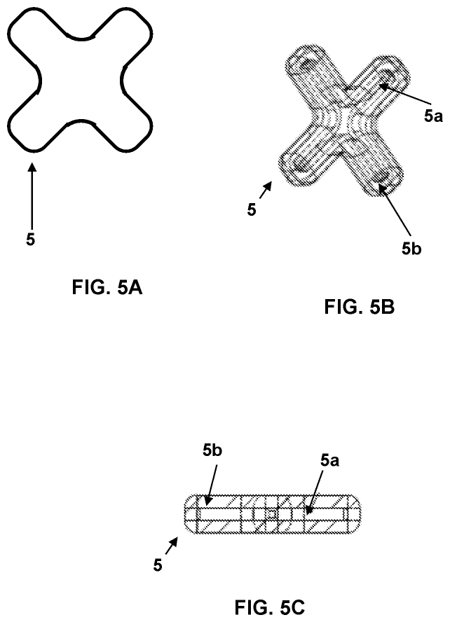

FIG. 5A is a top view of an X-shaped stirrer 5 for the bottle and stirrer combination.

FIG. 5B is an interior view of the stirrer 5 showing the ferromagnetic material 5a enclosed within a casing 5b.

With continued reference to FIG. 5B, FIG. 5C is a transverse cross-sectional view of the stirrer 5 showing the ferromagnetic material 5a enclosed within the casing 5b.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below.

1: A bottle and stirrer combination, comprising:
a bottle body comprising a base and a neck formed at a mouth of the bottle body and in fluid connection therewith, said bottle body designed to contain a cosmetic formulation for dispensing;
a cap removably engageable with the neck; and
a stirrer that has an X-shape, or a Y-shape comprising a magnetic material disposed on the base within the bottle body.

2: The bottle and stirrer combination of claim 1, further comprising an applicator made of a non-magnetic material depending longitudinally from an inner surface of the cap into the bottle body.

3: The bottle and stirrer combination of claim 2, wherein the applicator comprises a brush or a sponge attached at a distal end thereof.

4: The bottle and stirrer combination of claim 2, wherein the applicator has a length less than a distance from the inner surface of the cap to the stirrer disposed on the base within the bottle body.

5: The bottle and stirrer combination of claim 2, wherein the applicator is made from at least one material selected from the group consisting of a glass, a polymer, a polymer composite, a non-magnetic metal, and a non-magnetic metal composite.

6: The bottle and stirrer combination of claim 1, wherein the neck is exteriorly threaded and the cap is interiorly threaded.

7: The bottle and stirrer combination of claim 1, wherein the bottle body and the neck are independently made from at least one material selected from the group consisting of a glass, a polymer, and a polymer composite.

8: The bottle and stirrer combination of claim 1, wherein the cap is made from at least one material selected from the group consisting of a glass, a polymer, a polymer composite, a non-magnetic metal, and a non-magnetic metal composite.

9: The bottle and stirrer combination of claim 1, wherein the bottle body has a substantially cuboidal shape, or a substantially cylindrical shape, or a substantially hemispherical shape.

10: The bottle and stirrer combination of claim 1, wherein the stirrer has dimensions less than areal dimensions of an inner surface of the base of the bottle body.

11: The bottle and stirrer combination of claim 1, wherein the stirrer comprises a non-magnetic casing.

12. (canceled)

13: The bottle and stirrer combination of claim 1, wherein the cosmetic fluid is a nail polish, a nail lacquer, a nail sealant, or a nail gel.

14: A bottle and stirrer combination for mixing a cosmetic formulation, comprising:
a bottle body with a base at a distal end and a mouth at a proximal end designed to contain the cosmetic formulation;
a neck with exterior threading formed at the mouth of the bottle body and in fluid connection therewith;
a cap with interior threading removably, threadably engageable with the neck;
a non-magnetic applicator depending longitudinally from an inner surface of the cap into the bottle body; and
a stirrer that has an X-shape, or a Y-shape comprising a magnetic material and a non-magnetic coating encasing the stirrer disposed on the base within the bottle body.

15: The bottle and stirrer combination of claim 14, wherein the bottle body has a substantially cuboidal shape, or a substantially cylindrical shape, or a substantially hemispherical shape.

16: The bottle and stirrer combination of claim 14, wherein the non-magnetic applicator has a length less than a distance from the inner surface of the cap to the magnetic stirrer on the base within the bottle body.

17: The bottle and stirrer combination of claim 14, wherein the non-magnetic applicator comprises a brush or a sponge attached at a distal end thereof.

18: The bottle and stirrer combination of claim 14, wherein the bottle body and the neck are independently made from at least one material selected from the group consisting of a glass, a polymer, and a polymer composite.

19: The bottle and stirrer combination of claim 14, wherein the non-magnetic applicator and the cap are independently made from at least one material selected from the group consisting of a glass, a polymer, a polymer composite, a non-magnetic metal, and a non-magnetic metal composite.

20: The bottle and stirrer combination of claim 14, wherein the stirrer has dimensions less than areal dimensions of an inner surface of the base of the bottle body.

21. (canceled)

22: The bottle and stirrer combination of claim 14, wherein the cosmetic formulation is a nail polish, a nail lacquer, a nail sealant, or a nail gel.
